(19) United States
(12) Patent Application Publication
(10) Pub. No.: US 2006/0156912 A1
(43) Pub. Date: Jul. 20, 2006

(54) ELECTRIC GUITAR WITH CASCADED VOICE AND MODE CONTROLS AND LAMINATED THROUGH BODY AND METHOD THEREOF

(76) Inventors: Ross A. Annis, Tonawanda, NY (US); Frank J. Pirrone, Buffalo, NY (US)

Correspondence Address: SIMPSON & SIMPSON, PLLC, 5555 MAIN STREET, WILLIAMSVILLE, NY, 14221-5406, US

(21) Appl. No.: 10/905,752

(22) Filed: Jan. 19, 2005

(51) Int. Cl. G10H 3/12; G10H 1/18

(52) U.S. Cl. 84/742

(57) ABSTRACT

The present invention broadly comprises an electric guitar including a first pickup with first and second coils, a second pickup with third and fourth coils, a first switch connected to the first pickup, and a second switch connected to the second pickup. The first and second switches are arranged to select series, coil tapping, and parallel configurations of the first and second and third and fourth coils, respectively. A selector switch is connected to respective outputs of the first and second switches and arranged to select the first switch output, the second switch output, a series connection of the first and second switch outputs, a series out-of-phase connection of the first and second switch outputs, a parallel connection of the first and second switch outputs, and a parallel out-of-phase configuration of the first and second switch outputs.

### FIELD OF THE INVENTION

The present invention relates generally to electric guitars. In particular, it relates to an arrangement to select pick up coil configurations and combining pick up outputs. The present invention also relates to laminating guitar bodies and necks using a plurality of hardwoods.

### BACKGROUND OF THE INVENTION

It is desirable to increase the variety of tonalities available from an electric guitar. This can be done by increasing the number and type of pickups used on the guitar. For example, a common configuration uses humbucker neck and bridge pickups and a single-coil intermediate pickup. Unfortunately, adding additional pickups adds to the expense of the guitar and the complexity of the wiring. It is known to use multiple-position switches to create various combinations of pickup outputs. For example, U.S. Pat. No. 5,780,760 discloses three single-coil pickups and a switching arrangement to enable seven combinations. Unfortunately, only in-phase, serial connections are used and therefore, with three single-coil pickups, no more than seven total pickup combinations are possible. U.S. Pat. No. 5,136,918 discloses the three pickup system noted above and a two-gang, five position switch to select pickup outputs. Unfortunately, this system is limited to only five combinations only and does not include the capability to select/combine individual coils in the humbucker pickups. U.S. Pat. No. 5,311,806 discloses the same pickup configuration with a four gang, five-position switch. Unfortunately, this arrangement is still limited to only 10 combinations and does not enable humbucker coil selection/combining.

U.S. patent application No. US 2003/0145715 discloses a cascaded system of switches for a guitar having three single-coil pickups. The system uses three double-pole, double throw (center off) phase switches connected to the coils. The phase switches are connected to three double-pole, double throw (center off) connection switches. Unfortunately, the guitar is limited to only three coils, which limits the number of combinations possible. Also, a large number of switches are used, adding the difficulty in using the guitar, particularly when a player wished to switch settings while playing, and diminishing the aesthetic appeal of the instrument. U.S. Pat. No. 5,763,808 uses the two humbucker and intermediate pickup arrangement noted above. Output combinations are selected by a four-gang three-way switch connected to the pickups and a two-gang five-position switch between the three-way switch and the volume and tone controls. Unfortunately, this arrangement is limited to 15 combinations of single coils or series combinations of coils. Also, parallel combinations are not possible.

U.S. Pat. No. 5,136,919 discloses multiple pickups and a rotary switch to control arrays of field-effect-transistor (FET) switches connected to the pickups. Unfortunately, this system does not select coil configurations within a pickup and can only provide a limited number of pickup combinations. Further, the rotary switch can be clumsy to use and it may be hard to replicate settings while playing the guitar. Further, the system introduces the extra cost and complexity of FET switches and buffer and mixing circuitry.

U.S. Pat. No. 6,316,713 discloses a drive apparatus with a programmable microprocessor to control a relatively large number of switches connected to pickup coils. The system can produce a variety of coil combinations. Unfortunately, the system adds the cost and additional requirements associated with the electronics and the microprocessor. In addition, the system requires a large number of switches, adding to cost and bulkiness.

What is needed is an electric guitar having a maximum number of coil configurations using a minimal number of pickups and simple, readily available switching devices.

### BRIEF SUMMARY OF THE INVENTION

The present invention broadly comprises an electric guitar including a first pickup with first and second coils, a second pickup with third and fourth coils, a first switch connected to the first pickup and arranged to select a series configuration and a coil tapping configuration of said first and second coils, and a second switch connected to the second pickup and arranged to select a series configuration and a coil tapping configuration of the third and fourth coil. The guitar also includes a selector switch connected to respective outputs of the first and second switches and arranged to select, the first switch output, the second switch output, a series connection of the first and second switch outputs, a series out-of-phase connection of the first and second switch outputs, and a parallel connection of the first and second switch outputs.

In some aspects, the first switch also is arranged to select a parallel configuration of the first and second coils and the second switch is arranged to select a parallel configuration of the third and fourth coils. The guitar can include a third switch connected to the selector switch and arranged to select a parallel out-of-phase configuration of the first and second switch outputs. For some series connections, the first coil is located further from the bridge and the third coil is located closer to the first bridge.

The guitar also includes a through body and first and second wing sections fixedly attached to the through body. The through body includes a body component and a neck and is made of a plurality of first maple wood layers and a plurality of first tropical hardwood layers laminated together. Each said wing section is made of a plurality of second maple wood layers and a plurality of second tropical hardwood layers laminated together. Adjoining sides of said second maple layers and said second tropical hardwood layers are oriented substantially orthogonal to said first maple layers and said first tropical hardwood layers. The first tropical hardwood is selected from the group consisting of bloodwood and bubinga and the second tropical hardwood is selected from the group consisting of mahogany, cocobolo, and purpleheart. The body component further comprises a two-step top surface and the first and second wings extend beyond a top surface of the body component.

The present invention also includes a method for selecting configurations of dual-coil pickups in an electric guitar.

It is a general object of the present invention to provide a guitar and method for selecting the maximum number of coil combinations for two dual-coil pickups.

It is another object of the present invention to provide a guitar and method with a cascaded switching arrangement for selecting coil combinations within each pickup at a first level and selecting combinations of the first level selections at a second level.

It is still another object of the present invention to provide a guitar and method using simple, readily available switches to implement the cascaded switching arrangement.

It is yet another object of the present invention to provide a guitar and method providing a large number of coil combinations that are easily and intuitively selectable by the guitar user.

It is a still further object of the present invention to provide a guitar having a laminated structure consisting of layers of maple and tropical hardwoods.

### BRIEF DESCRIPTION OF THE DRAWINGS

The nature and mode of operation of the present invention will now be more fully described in the following detailed description of the invention taken with the accompanying drawing figures, in which:

FIG. 1 is an isometric view of a present invention guitar;

FIG. 2 is a wiring diagram showing two double throw voice selector switches;

FIG. 3 is a wiring diagram showing two three pole voice selector switches;

FIG. 4 is a back view of the guitar in FIG. 1, showing a laminated through body and wings;

FIG. 5 is a cross-sectional view along lines 5-5 in FIG. 1; and,

FIG. 6 is an isometric view of the guitar in FIG. 1 with the bridge and strings removed.

### DETAILED DESCRIPTION OF THE INVENTION

At the outset, it should be appreciated that like drawing numbers on different drawing views identify substantially identical structural elements of the invention. While the present invention is described with respect to what is presently considered to be the preferred embodiments, it is understood that the invention is not limited to the disclosed embodiments.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

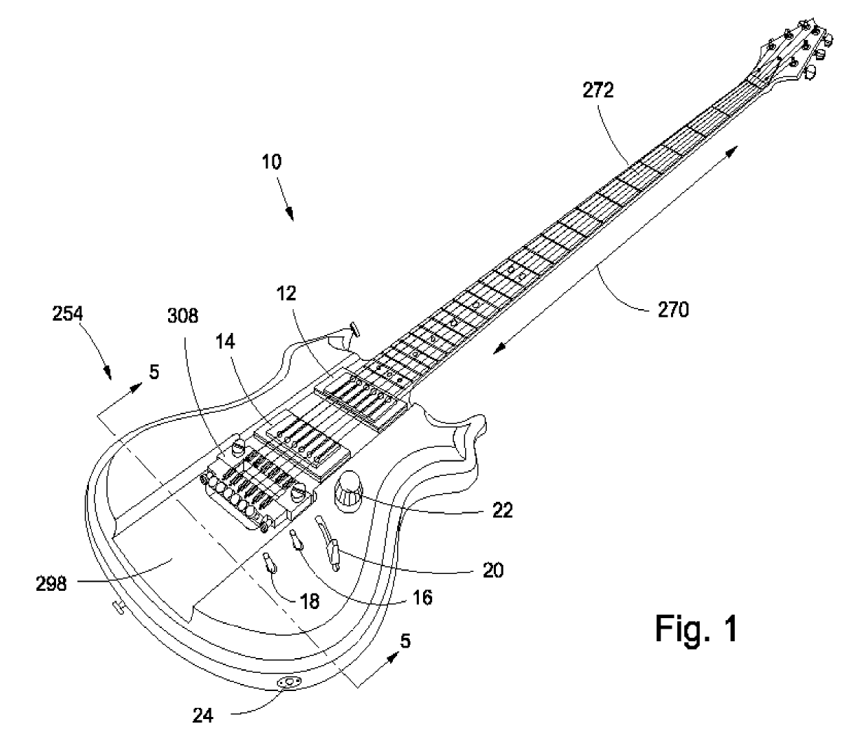

FIG. 1 is an isometric view of a present invention guitar 10. Guitar 10 is shown as a 6-string electric guitar, however, it should be understood that guitar 10 can have other numbers of strings and such modifications are within the spirit and scope of the claims. Guitar 10 includes neck pickup 12, bridge pickup 14, neck voice switch 16, bridge voice switch 18, and mode selector switch 20. Pickups 12 and 14 are dual coil pickups. In some aspects, the pickups are humbucking pickups. In some aspects, voice switches 16 and 18 are two pole switches and have two or three throws as further described below. Mode selector switch 20 is a five-position switch. Guitar 10 also includes concentric volume and tone control 22 and output 24. hi some aspects (not shown), volume and tone controls are separate, respective knobs. It should be understood that guitar 10 is not limited to the present spatial arrangement of switches and controls and other arrangements are included within the spirit and scope of the claims.

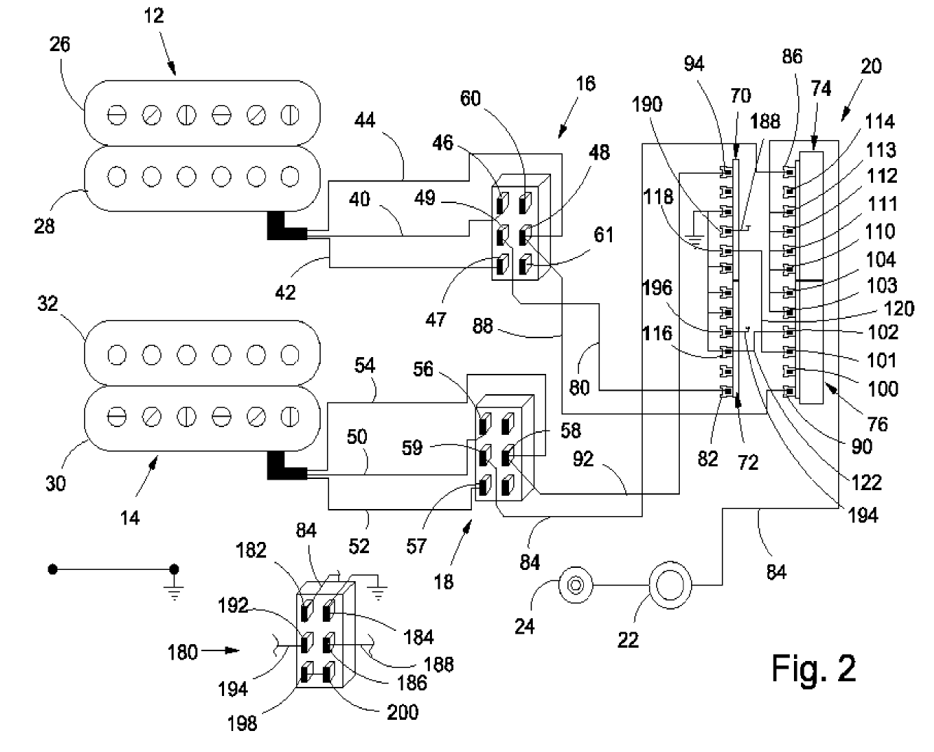

FIG. 2 is a wiring diagram showing two double throw voice selector switches 16 and 18. Pickup 12 includes coils 26 and 28 and pickup 14 includes coils 30 and 32. In some aspects, coils 26 and 28 and 30 and 32 are connected in series, respectively. In some aspects, switches 16 and 18 are double pole, double throw switches, also known as on/on switches. That is, there is no center on position for the switches. For pickup 12, wire 40 is connected to one end of coil 28, wire 42 is connected to the other end of coil 28 and one end of coil 26, that is, a center tap point between the two coils, and ground wire 44 is connected to the other end of coil 26. For switch 16, wire 40 is connected to terminal 46, wire 42 is connected to terminal 47, and ground wire 44 is connected to terminal 48. Terminal 49 is an output terminal. For pickup 14, wire 50 is connected to one end of coil 32, wire 52 is connected to the other end of coil 32 and one end of coil 30, that is, a center tap point between the two coils, and ground wire 54 is connected to the other end of coil 30. For switch 18, wire 50 is connected to terminal 56, wire 52 is connected to terminal 57, and ground wire 54 is connected to terminal 58. Terminal 59 is an output terminal.

Switches 16 and 18 each select two configurations for the coils in pickups 12 and 14, respectively. The following description for pickup 12 and switch 16 also is applicable to pickup 14 and switch 18. In a first position, terminals 49 and 46 are connected and terminals 48 and 60 are connected, selecting a series connection of coils 26 and 28 at output 49. In a second position, terminals 49 and 47 are connected and terminals 48 and 61 are connected, selecting coil 26 at output 49. Thus, four different configurations of coils for pickups 12 and 14 can be selected as inputs to switch 20.

In some aspects, switch 20 is a two gang, four pole, five position switch. In those aspects, switch 20 includes poles 70, 72, 74, and 76. Each pole has five positions. Line 80 connects output terminal 49 to input terminal 82 of pole 72. Line 84 connects output terminal 59 to input terminal 86 of pole 74. Line 88 connects ground terminal 48 to input terminal 90 of pole 76. Line 92 connects ground terminal 58 to input terminal 94 of pole 70. Poles 70, 72, 74, and 76 can be considered busses that are fed by terminals 94, 82, 86, and 90 respectively. Terminals 100-104 in pole 76 each correspond to one of the five positions of switch 20, or alternately stated, the five configurations selectable using switch 20. For example, terminals 100-104 correspond to positions 1 through 5 respectively. In the same manner, terminals 110-114 in pole 74 correspond to positions 1 through 5 respectively. The terminals in poles 70 and 72 are similarly configured. The five positions of switch 20 provide the following configurations of output terminals 49 and 59 (hereinafter referred to as outputs 49 and 59) at output lead 84. Position 1 (terminal 100) selects output 59 only. Position 2 (terminal 101) selects a series configuration of outputs 49 and 59. Position 3 (terminal 102) selects a series, out-of-phase configuration of outputs 49 and 59. Position 4 (terminal 103) selects a parallel configuration of outputs 49 and 59. Position 5 (terminal 104) selects output 49 only. Thus, 16 different configurations of coils for pickups 12 and 14 can be selected as an output from switch 20.

The following is a description of the coil configuration obtained by selecting the first position for switches 16 and 18 and position 2 for switch 20. In operation, the terminals in switch 20 corresponding to the selected position are activated. For example, in position 2, terminals 101, 111, 116, and 118 are selected or activated. Lead 120 connects terminals 101 and 118 and lead 122 connects terminals 102 and 116. Therefore, in the above described configuration, switch 20 selects (position 2) the serial connection of coils 26 and 28 (the first position) at terminal 90 with the serial connection of coils 30 and 32 (the first position) at terminal 86 to create the output on lead 84.

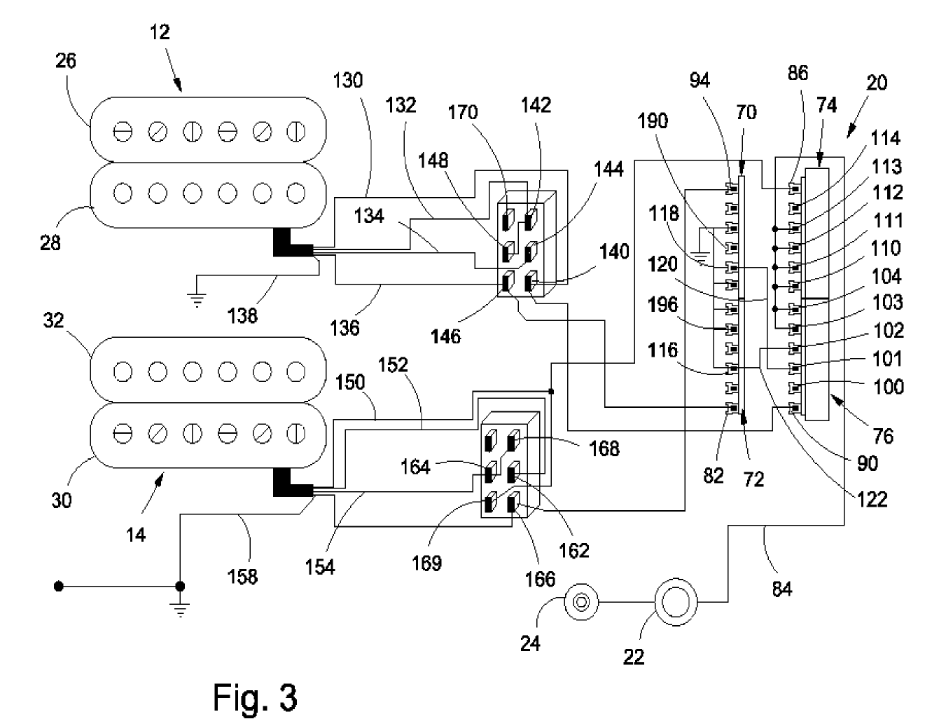

FIG. 3 is a wiring diagram showing two triple throw voice selector switches 16 and 18. In some aspects, switches 16 and 18 are double pole, triple throw switches, also known as on/on/on switches. For these aspects, pickups 12 and 14 have four lead wires and a ground wire. For pickup 12, wire 130 is connected to one end of coil 26, wire 132 is connected to the other end of coil 26, wire 134 is connected to one end of coil 28, wire 136 is connected to the other end of coil 28, and wire 138 is connected to ground. The ends of coils 26 and 28 connected to wires 130 and 134, respectively, have a matching polarity. For switch 16, wire 130 is connected to terminal 140, wire 132 is connected to terminal 142, wire 134 is connected to terminal 144, and wire 136 is connected to terminal 146. Terminal 148 is jumped to terminal 142. Terminal 140 is an output terminal. For pickup 14, wire 150 is connected to one end of coil 32, wire 152 is connected to the other end of coil 32, wire 154 is connected to one end of coil 30, wire 156 is connected to the other end of coil 30, and wire 158 is connected to ground. The ends of coils 32 and 30 connected to wires 150 and 154, respectively, have a matching polarity. For switch 18, wire 150 is connected to terminals 160 and 86, wire 152 is connected to terminal 162, wire 154 is connected to terminal 164, and wire 156 is connected to terminal 166. Terminal 168 is jumped to terminal 164. Terminal 169 is an output terminal.

Switches 16 and 18 each select three configurations for the coils in pickups 12 and 14, respectively. The following description for pickup 12 and switch 16 also is applicable to pickup 14 and switch 18. In a first position, terminals 148 and 170 are connected and terminals 144 and 142 are connected, selecting a series connection of coils 26 and 28 at output 140. In a second position, terminals 148 and 146 are connected and terminals 144 and 142 are connected, selecting coil 26 at output 140. In a third position, terminals 148 and 146 are connected and terminals 144 and 140 are connected, selecting a parallel connection of coils 26 and 28 at output 140. Thus, nine different configurations of coils for pickups 12 and 14 can be selected as inputs to switch 20.

In some aspects, switch 20 is a two gang, four pole, five position switch. The description for switch 20 in FIG. 2 is applicable to switch 20 in FIG. 3. Thus, the five positions of switch 20 provide the same configurations of output terminals 140 and 169 as described for output terminals 49 and 59 in FIG. 2. Since switches 16 and 18 can provide nine different inputs to switch 20, 33 different configurations of coils for pickups 12 and 14 can be selected as an output from switch 20.

Returning to FIG. 2, in some aspects, guitar 10 includes a third voice selector switch 180. Switch 180 is not shown in FIG. 1, however, a slide or other control means for switch 180 can be located near switches 16 and 18. In some aspects, switch 180 is an internal switch. Switch 180 is used in conjunction with position 3 of switch 20. Switch 180 is shown with double pole, double throw switches 16 and 18. However, it should be understood that switch 180 can be used with any type or combination of switches 16 and 18. In some aspects, switch 180 is a double pole, double throw switch, also referred to as an on/on switch. Terminal 182 is connected to lead 84 and terminal 184 is connected to ground. Terminal 186 is connected with lead 188 to terminal 190 in pole 70 and terminal 192 is connected with lead 194 to terminal 196 in pole 72. Terminals 198 and 200 are connected together. In a first position of switch 180, terminal 186 is connected to terminal 184 and terminal 192 is connected to terminal 182. As a result, terminal 48 (ground) of switch 16 is connected to ground through terminal 103 and lead 202. Terminal 49 (output) of switch 16 is connected to lead 84. Terminal 58 (ground) of switch 18 is connected to lead 84 and terminal 59 (output) of switch 1 is grounded, thus reversing the polarity of the switch 18 output. As a result, the outputs of switches 16 and 18 are combined in a parallel, out-of-phase configuration. hi a second position of switch 180, terminal 186 is connected to terminal 200 and terminal 192 is connected to terminal 198. This is the same configuration as the original position 3 described for FIG. 2.

The following should be viewed in light of FIGS. 1-3. The descriptions for FIGS. 1-3 describe a cascaded system for selecting configurations of coils for pickups on guitar 10. The first level is formed by switches 16 and 18 that select the coil configurations within each pickup. The second level is formed by switches 20 and 180 that select configurations of the outputs from switches 16 and 18. This arrangement uses a minimal number of readily available switching devices. Due to the cascading arrangement, up to 42 configurations are available for two dual-pickup coils, using only four simple switches. Guitar 10 presents a powerful and intuitive system of selecting tonalities. Guitar 10 first presents the user with a family of modes, selected by switches 20 and 180: powerful or fat (series), hollow or spacey (series, out-of-phase), twangy or acoustic (parallel), or acoustic/spacey (parallel, out-of-phase). Of course, the user also can select just the output from switch 16 or 18. The user then can “color” the mode using switches 16 and 18, which provide the following sounds for each pickup: thick (series), clean (coil tapping), or full (parallel). Thus, the user can quickly learn to associate the various sounds possible using the simple switch settings, to easily visualize the settings needed, and to quickly select the settings to “customize” the sound of the guitar. Also, the ability to repeat desired configurations is enhanced by the fact that configurations are associated with relatively simple combinations of switch settings.

In FIG. 2, pickups 12 and 14 have the same number of leads and switches 16 and 18 had the same number of poles and throws. The same holds true for FIG. 3. However, it should be understood that the respective configurations of the pickups and voice switches do not need to match. For example, the pickup 12 and switch 16 configurations shown in FIG. 2 can be combined with the pickup 14 and switch 18 configurations shown in FIG. 3. It should be understood that switches 16, 18, 20, and 180 are meant to be readily available switches, well known in the art. The present invention is not limited to any particular type of two-way, three-way, or five-position switches and can be implemented using any switches known in the art that can implement the switching functions described in the Detailed Description and claims.

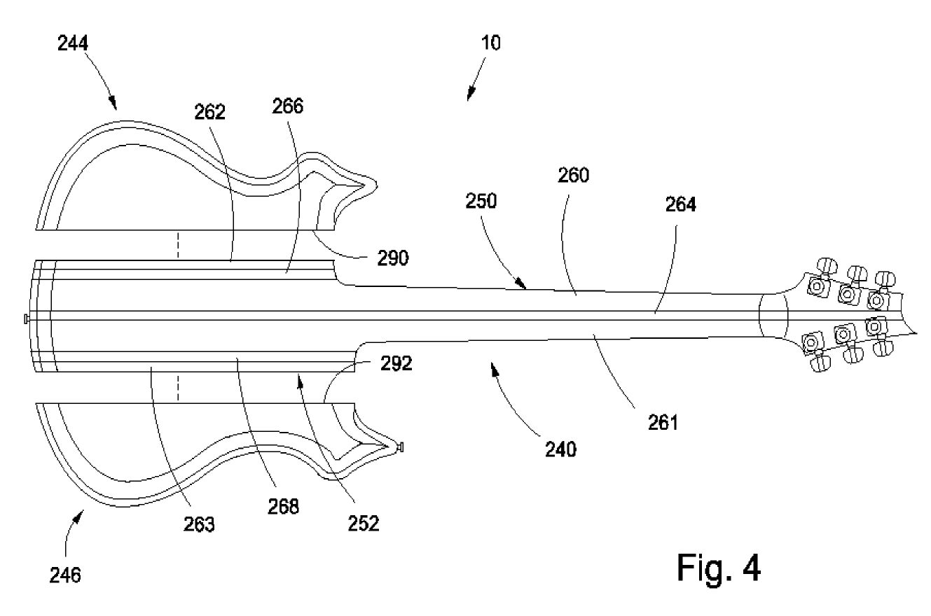

FIG. 4 is a back view of the guitar in FIG. 1, showing laminated through body 240 and wings 244 and 246. The following should be viewed in light of FIGS. 1 and 4. Guitar 10 includes through body 240 and wings 244 and 246. Through body 240 includes neck 250 and body component 252, which forms the core of body 254 of guitar 10. Through body 240 is formed of laminated layers of maple and tropical hardwoods. For example, maple layers 260 through 263 and tropical hardwood layers 264, 266, and 268. It should be understood that through body 240 is not limited to any particular number or combination of maple and tropical hardwood layers. The laminated layers in through body 240 are oriented so that the adjoining or laminated sides/faces of the layers are substantially parallel to a longitudinal axis 270 of neck 250. Fretboard 272 is connected to neck 250 on bottom side (not shown). The laminated layers are substantially orthogonal to the bottom side. The tropical hardwoods have a specific gravity of at least 0.7. In some aspects, the tropical hardwood is bloodwood or bubinga. In some aspects, layers 260 and 261 are 1.875 inches thick and layers 262 and 263 are 0.357 inches thick. Then, layers 264, 266, and 268 are bloodwood. Layer 264 is 0.463 inches thick and layers 266 and 268 are 0.357 inches thick. Thickness are measured orthogonal to the laminated sides of the respective layers.

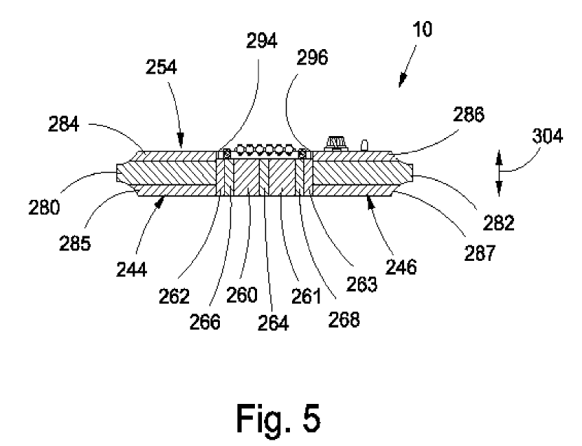

FIG. 5 is a cross-sectional view along lines 5-5 in FIG. 1. The following should be viewed in light of FIGS. 1, 4, and 5. Wings 244 and 246 are fixedly attached to through body 240, substantially along body component 252. Each wing section is formed of laminated layers of hardwoods including maple and tropical hardwoods. For example, layers 280 and 282 are of one type of wood and layers 284-287 are of a different type of wood. It should be understood that wings 244 and 246 are not limited to any particular number or combination of layers. The laminated layers in wings 244 and 246 are oriented substantially orthogonal to the laminated layers in through body 240. In some aspects, the tropical hardwood is mahogany, cocobolo, or purpleheart. Wings 244 and 246 are connected to through body 240 at sides 290 and 292, respectively. In some aspects, portions 294 and 296 of sides 290 and 292, respectively, extend beyond top surface 298 of through body 240. In some aspects, layers 280 and 282 are mahogany and are 0.700 inches thick. Then, layers 284-287 are bloodwood. Layers 285 and 287 are 0.500 inches thick and layers 284 and 286 are 0.675 inches thick. Thickness are measured orthogonal to the laminated sides of the respective wing layers.

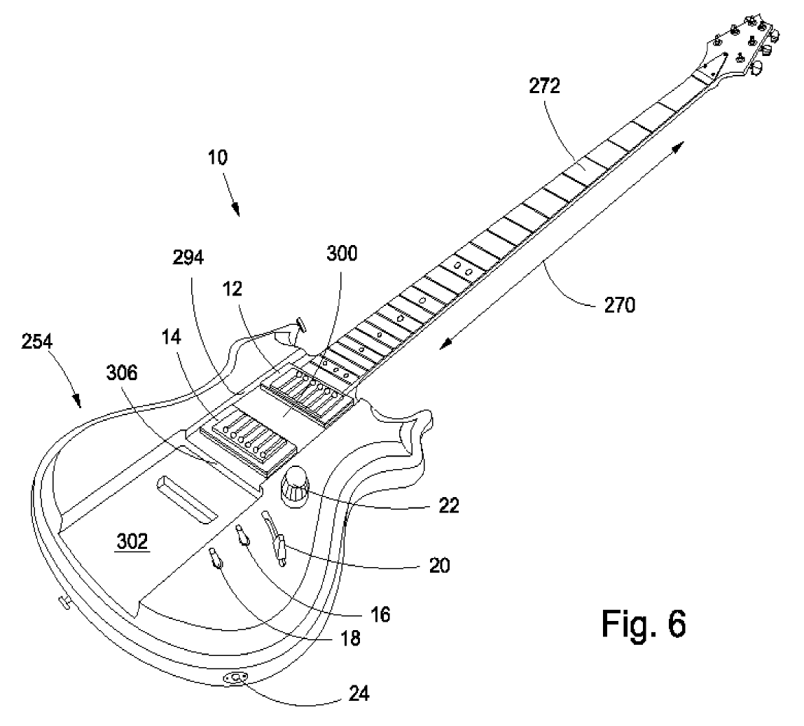

FIG. 6 is an isometric view of the guitar in FIG. 1 with the bridge and strings removed. The following should be viewed in light of FIGS. 1 and 4-6. In some aspects, core 254 includes a first portion 300 having a greater thickness than a second portion 302. The thickness is measured with respect to a line 304 orthogonal to the plane (not shown) of fretboard 272. Step 306 joins portions 300 and 302. Bridge 308 is located in portion 302.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. An electric guitar comprising:
a first pickup comprising first and second coils;
a second pickup comprising third and fourth coils;
a first switch connected to said first pickup and arranged to select a series configuration and a coil-tapping configuration of said first and second coils;
a second switch connected to said second pickup and arranged to select a series configuration and a coil tapping configuration of said third and fourth coils; and,
a selector switch connected to respective outputs of said first and second switches and arranged to select said first switch output, said second switch output, a series connection of said first and second switch outputs, a series out-of-phase connection of said first and second switch outputs, and a parallel connection of said first and second switch outputs.

2. The electric guitar of claim 1 said wherein first switch is arranged to select a parallel configuration of said first and second coils and said second switch is arranged to select a parallel configuration of said third and fourth coils.

3. The electric guitar of claim 1 further comprising:
a third switch connected to said selector switch and arranged to select a parallel out-of-phase configuration of said first and second switch outputs.

4. The electric guitar of claim 1 further comprising:
a first bridge; and,
wherein said first coil is located further from said first bridge than said second coil, said third coil is located closer to said first bridge than said fourth coil, said coil tapping configuration of said first pickup is arranged to select said first coil, and said coil tapping configuration of said second pickup is arranged to select said third coil.

5. The electric guitar of claim 1 further comprising
a through body and a fretboard; and,
wherein said through body includes a body component and a neck, said body component forms a core for a body of said guitar, said neck has a longitudinal axis, and said fretboard has a side affixed to said neck; and,
wherein said through body is made of a plurality of maple wood layers and a plurality of tropical hardwood layers, said maple wood layers and said tropical hardwood layers are laminated together, said tropical hardwood has a specific gravity of at least 0.7, and laminated sides of said maple layers and said tropical hardwood layers are oriented substantially parallel to said longitudinal axis and orthogonal to said fretboard side.

6. The electric guitar of claim 5 wherein said tropical hardwood is selected from the group consisting of bloodwood and bubinga.

7. The electric guitar of claim 5 further comprising:
a second bridge; and,
wherein said body component further comprises a top surface divided into first and second areas by a step in said top surface, said first area has a first thickness measured orthogonal to a plane of said fretboard side, said second area has a second thickness, less than said first thickness, measured orthogonal to said plane of said fretboard side, and said second bridge is positioned in said second area.

8. The electric guitar of claim 5 further comprising:
first and second wing sections fixedly attached to said through body; and,
wherein each said wing section is made of a plurality of hardwood layers laminated together, said hardwood has a specific gravity of at least 0.7, and laminated sides of said hardwood layers are oriented substantially orthogonal to said first maple layers and said tropical hardwood layers.

9. The electric guitar of claim 8 wherein said hardwood is selected from the group consisting of maple, mahogany, cocobolo, and purpleheart.

10. The electric guitar of claim 8 wherein said first and second wings further comprise first and second wing side surfaces, respectively, said first and second wing side surfaces are connected to said through body and a portion of said first and second side surfaces extend beyond said top surface.

11. An electric guitar comprising:
a through body and a fretboard; and,
first and second wing sections fixedly attached to said through body; and,
wherein said through body includes a body component and a neck, said body component forms a core for a body of said guitar, said neck has a longitudinal axis, and said fretboard has a side affixed to said neck;
wherein said through body is made of a plurality of maple wood layers and a plurality of tropical hardwood layers, said maple wood layers and said tropical hardwood layers are laminated together, said tropical hardwood has a specific gravity of at least 0.7, and laminated sides of said maple layers and said tropical hardwood layers are oriented substantially parallel to said longitudinal axis and orthogonal to said fretboard side; and,
wherein each said wing section is made of a plurality of hardwood layers laminated together, said hardwood has a specific gravity of at least 0.7, and laminated sides of said hardwood layers are oriented substantially orthogonal to said first maple layers and said tropical hardwood layers.

12. The electric guitar of claim 12 wherein said tropical hardwood is selected from the group consisting of bloodwood and bubinga and said hardwood is selected from the group consisting of maple, mahogany, cocobolo, and purpleheart.

13. The electric guitar of claim 11 further comprising:
a bridge; and,
wherein said body component further comprises a top surface divided into first and second areas by a step in said top surface, said first area has a first thickness measured orthogonal to a plane of said fretboard side, said second area has a second thickness, less than said first thickness, measured orthogonal to a plane of said fretboard side, and said bridge is positioned in said second area.

14. The electric guitar of claim 11 wherein said first and second wings further comprise first and second wing side surfaces, respectively, said first and second wing side surfaces are connected to said through body and a portion of said first and second side surfaces extend beyond said top surface.

15. An electric guitar comprising:
a first pickup comprising first and second coils;
a second pickup comprising third and fourth coils;
a first two pole, three throw switch connected to said first pickup and arranged to select a series configuration, a parallel configuration, and a coil tapping configuration of said first and second coils;
a second two pole, three throw switch connected to said second pickup and arranged to select a series configuration, a parallel configuration, and a coil tapping configuration of said third and fourth coils;
a two gang, four pole, five position selector switch connected to respective outputs of said first and second switches and arranged to select said first switch output, said second switch output, a series connection of said first and second switch outputs, a series out-of-phase connection of said first and second switch outputs, and a parallel connection of said first and second switch outputs; and,
a two pole, two throw switch connected to said selector switch and arranged to select a parallel, out-of-phase configuration of said first and second switch outputs.

16. A method of selecting pickup coil combinations and laminating an electric guitar comprising:
selecting a first configuration including a series configuration and a coil tapping configuration of first and second coils in a first pickup;
selecting a second configuration including a series configuration and a coil tapping configuration of third and fourth coils in a second pickup; and,
selecting a third configuration including said first configuration, said second configuration, a series connection of said first and second configurations, a series out-of-phase connection of said first and second configurations, and a parallel connection of said first and second configurations.

17. The method recited in claim 16 wherein selecting a first configuration further comprises
selecting a parallel configuration of said first and second coils; and,
wherein selecting a second configuration further comprises selecting a parallel configuration of said third and fourth coils.

18. The method recited in claim 16 wherein selecting a third configuration further comprises selecting a parallel out-of-phase configuration of said first and second configurations.

19. The method recited in claim 16 wherein said guitar further comprises a fretboard with a side; and,
said method further comprising:
laminating alternating layers of a first hardwood selected from the group consisting of maple, bloodwood, and bubinga to form a through body including a body component and a neck for said guitar;
attaching said fretboard side to said neck;
laminating alternating layers of a second hardwood selected from the group consisting of maple, mahogany, cocobolo, and purpleheart to form first and second wing sections, wherein laminated sides of said first hardwood layers are oriented substantially orthogonal to said fretboard side and orthogonal to laminated sides of said second hardwood layers; and,
attaching said wing sections to said body component.

20. The method recited in claim 19 wherein said body component further comprises a top surface and said first and second wings further comprise first and second wing side surfaces; and, wherein attaching said wing sections to said body component further attaching said first and second wing side surfaces to said through body so that a portion of said first and second side surfaces extend beyond said top surface.
